(19) United States
(12) Patent Application Publication
(10) Pub. No.: US 2004/0044537 A1
(43) Pub. Date: Mar. 4, 2004

(54) System and method for determining a shipping configuration for a part

(76) Inventors: Michael R. Aberle, Pekin, IL (US); Patrick J. Greenan, Peoria, IL (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/228,860

(22) Filed: Aug. 27, 2002

(51) Int. Cl. G06F 17/60

(52) U.S. Cl. 705/1

(57) ABSTRACT

A computer based system and method determines a shipping configuration for a part. The system and method establishes a set of part characteristics and determines the shipping configuration for the part as a function of the part characteristics. The shipping configuration includes a container, a number of parts in the container, and a layout of the parts in the container.

### TECHNICAL FIELD

The present invention relates generally to the shipping configuration of parts, and more particularly, to a computer based system and method of determining a shipping configuration of a part based on characteristics of the part.

### BACKGROUND

Typically, a company may receive material, e.g., parts, from many different parties or suppliers. Some companies may use standard containers, e.g., standard sized tubs, to receive the parts. Standard containers may vary in terms of size, shape, material, etc . . . . Often, these standard containers are re-usable, i.e., once the parts are received by the company, the container is shipped back to the supplier to be used again.

To ship a quantity of parts, a container must be chosen and then a quantity of parts are placed within the container. Previously, a number of parts desired to be shipped was determined and a container was selected that will carry the desired number of parts. Additionally, the parts were laid or placed in the container in an ad hoc manner, meaning that a container carrying one type of part may be packed completely differently than the same type of container carrying the same type of part, packed by a different packer, or the same packer at a different time.

Different packing styles may lead to different quantities of the same part being loaded into identical containers, leading to both cost and time inefficiencies, e.g., in transportation costs.

Additionally, a container may be selected to accommodate the desired quantity to be delivered without any determination regarding the cost effectiveness of using that particular container or the ordering that particular quantity.

The present invention is aimed at one or more of the problems identified above.

### SUMMARY OF THE INVENTION

In one aspect of the present invention, a method for determining a shipping configuration for a part is provided. The method includes the steps of establishing a set of part characteristics and determining the shipping configuration for the part as a function of the part characteristics. The shipping configuration includes a container, a number of parts in the container, and a layout of the parts in the container.

In another aspect of the present invention, a computer based system for determining a shipping configuration for a part is provided. The system includes a database for storing packaging data and a processing unit coupled to the database. The processing unit establishes a set of part characteristics and determines the shipping configuration for the part as a function of the part characteristics. The shipping configuration includes a container, a number of parts in the container, and a layout of the parts in the container.

### BRIEF DESCRIPTION OF THE DRAWINGS

FIG. 1 is a block diagram of a system for determining a shipping configuration for a part, according to an embodiment of the present invention;

FIG. 2 is a first flow diagram of a method for determining a shipping configuration for a part, according to an aspect of the present invention;

FIG. 3 is a second flow diagram of a method for determining a shipping configuration for a part, according to another aspect of the present invention;

FIG. 4 is a block diagram of a computer program product for determining a shipping configuration for a part, according to an aspect of the present invention;

FIG. 5 is a block diagram of a computer program product for determining a shipping configuration for a part, according to another aspect of the present invention;

FIG. 6A is a first diagrammatic illustration of a graphical user interface, according to an embodiment of the present invention;

FIG. 6B is a second diagrammatic illustration of the graphical user interface of FIG. 6A;

FIG. 6C is a third diagrammatic illustration of the graphical user interface of FIG. 6A;

FIG. 7A is a first diagrammatic illustration of a container information window, according to an embodiment of the present invention;

FIG. 7B is a second diagrammatic illustration of the container information window of FIG. 7A;

FIG. 7C is a third diagrammatic illustration of the container information window of FIG. 7A;

FIG. 8 is a diagrammatic illustration of a container layout window, according to an embodiment of the present invention;

FIG. 9A is a diagrammatic illustration of an EOQ estimation window, according to an embodiment of the present invention; and,

FIG. 9B is a second diagrammatic illustration of the EOQ estimation window of FIG. 9A.

### DETAILED DESCRIPTION

With reference to the drawings and in operation, the present invention provides a system 100 and method 200, 300 for determining a shipping configuration for a part. As discussed below, the shipping configuration for the part may include a container and an economic order quantity (EOQ) or portion thereof.

In one embodiment, the system 100 includes a database 102 for storing configuration, or packaging data and a processing unit 106 coupled to the database 102. The processing unit establishes a set of part characteristics and determines the shipping configuration for the part as a function of the part characteristics.

As discussed below, the shipping configuration may include a container, a number of parts in the container, and a layout of the parts in the container. The layout of the parts refers to how the parts are stacked or orientated with respect to the container. In one embodiment a graphic is shown illustrating the orientation of the parts within the container. Alternatively, only a portion of the parts in the recommended layout or orientation are shown.

In one embodiment of the present invention, a user 110 may establish information related to the part to be shipped and the system 100 and method 200, 300 generate the shipping configuration.

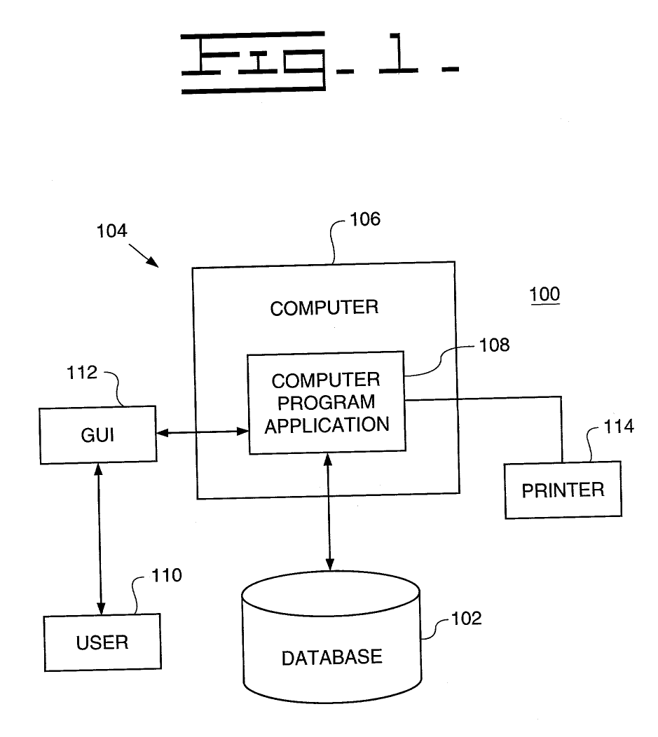

With particular reference to FIG. 1, the system 100 includes the database 102 and the processing unit 104. In one embodiment of the present invention, the processing unit 104 is embodied in a computer 106 and a computer program application 108 running on the computer. The user 110 interacts with the computer program application 108 through a graphical user interface or “GUI” 112. Furthermore in another embodiment, the system 100 may include a plurality of computers 106 which are connected into a network. Specified computers or users on the network having access to the system and methods of the present invention.

In one embodiment, the system 100 may include a printer 114 which allows packaging information and other data to printed on paper. Alternatively, the printer 114 may be separate from the system 100.

In one aspect of the present invention, the database 102 has stored thereon configuration data such as, container and part data. The database 102 may also include user data. The shipping configuration is determined as a function of part characteristics which may be stored in a packaging database. In one embodiment, the computer program application 108 is a database application written for a database program, such as Microsoft Access, available from Microsoft Corporation of Redmond, Wash. Alternatively, at least a portion of the data may be input by a user.

In one embodiment of the present invention, the system 100 establishes at least one dimension associated with a part and a weight associated with the part. The system may also establish a part identification. As described below, in a first embodiment, the part identification, at least one dimension, and/or weight may be input by the user 110. In one aspect of the present invention, required information not provided by the user 110 is located within the database 102. In another aspect of the present invention, information not located within the database 102 is input by the user 110.

Additionally, the processing unit may establish a desired container or the desired container may be input by the user 110. As described below, the system 100 may recommend a recommended container. The recommended container may be the same as the desired container or another container. Alternatively, the system 100 may provide packaging information for both the desired container and the recommended container.

In one embodiment of the present invention, the shipping configuration includes the number of parts in the container (desired or recommended or both) and a layout of the parts in the container (desired or recommended or both).

In another aspect of the present invention, the system 100 establishes a dimension associated with the part. The dimension may be associated with at least one edge of the part. Alternatively, a dimension for a plurality of edges may be established. The dimension for the one or more edges may be input by the user 110. Additionally, the system 100 may establish one of the edges as having a specific orientation. For example, the system 100 may establish the part must be orientated in the container such that one edge is towards the bottom of the container. Alternatively, the system may establish a general shape associated with a part and at least one dimension associated with the general shape.

In still another aspect of the present invention, the system 100 may establish a set of usage characteristics for the part. The shipping configuration may then be determined as a function of the part characteristics and the usage characteristics.

For example, the usage characteristics may be indicative of the price for the part and/or a quantity of parts used over a period of time. The system 100 determines a most economic order quantity based on the usage characteristics. In one embodiment, the usages characteristics includes the part price and the annual usage quantity, i.e., the number of parts used during a year's time period.

Furthermore, the recommended container may be determined as function of an economic lot size.

In another aspect of the present invention a method of determining a shipping configuration for a part is disclosed. In one embodiment, the method includes the steps of establishing a set of part characteristics and determining the shipping configuration of the part as a function of the part characteristics. The shipping configuration may include a container and at least one of a number of parts in the container and a layout of the parts (or portion thereof) relative to the container. In the first step, a set of part characteristics is established. The set of part characteristics may be established via input from a user or read from a data file containing the part characteristics. Part characteristics may include part dimensions, part number, part weight, etc. . . . In one embodiment, a user may input part dimensions. For example, the user may input a length and/or a height of the part. Alternately, the user may select the dimensions from a menu. In still another embodiment, the user may enter a part or select a part from a list of available parts and the associated dimensions and/or weight of the part are obtained from the database 102.

Additionally, the desired number of parts to be shipped may be entered. As discussed below, the desired number of parts my be determined as a function of the estimated number of parts that will be needed in a specified period of time, such as a year, as well as the costs associated with shipping, storing, handling, the desired container or a recommended container, and the layout of parts within the container, etc.

In the second step, a shipping configuration is determined as a function of one or more of the part characteristics. In one embodiment, the shipping configuration may include a number of containers based on a quantity of the parts and the number of parts in each container. The shipping configuration may also include a recommended layout of the parts relative to the container. As discussed below, a graphic may be shown or used to illustrate the parts or a portion of the parts in the recommended layout.

In one embodiment, the user may provide a desired container. The system or method may also determine a recommended container. The desired container and the recommended container may both be illustrated together or separately and may include an illustration of the parts or a portion of the parts in a recommended layout.

A discussed below, the layout and container recommendations may be based on a cost benefit or economic analysis. For example, the system and method may determine an economic lot size as a function of the part price and the estimated annual usage. In one aspect of the present invention, the economical lot size is also determined as a function of external factors such as supply chain costs, for example, inventory costs and holding, distribution, and receiving costs, current part prices, past part prices, or a forecast of future part prices (see below).

In one aspect of the present invention, a weight limit for a container may be stored in the database 102. In one embodiment of the present invention, if a weight limit for a container is stored in the database 102, then a weight of the part may be required. If a weight limit is not stored in the database 102 for a container, then a weight of the part is optional. If the weight limit for a container is not in the database then weight of the part is not used in the determination of the economical lot size.

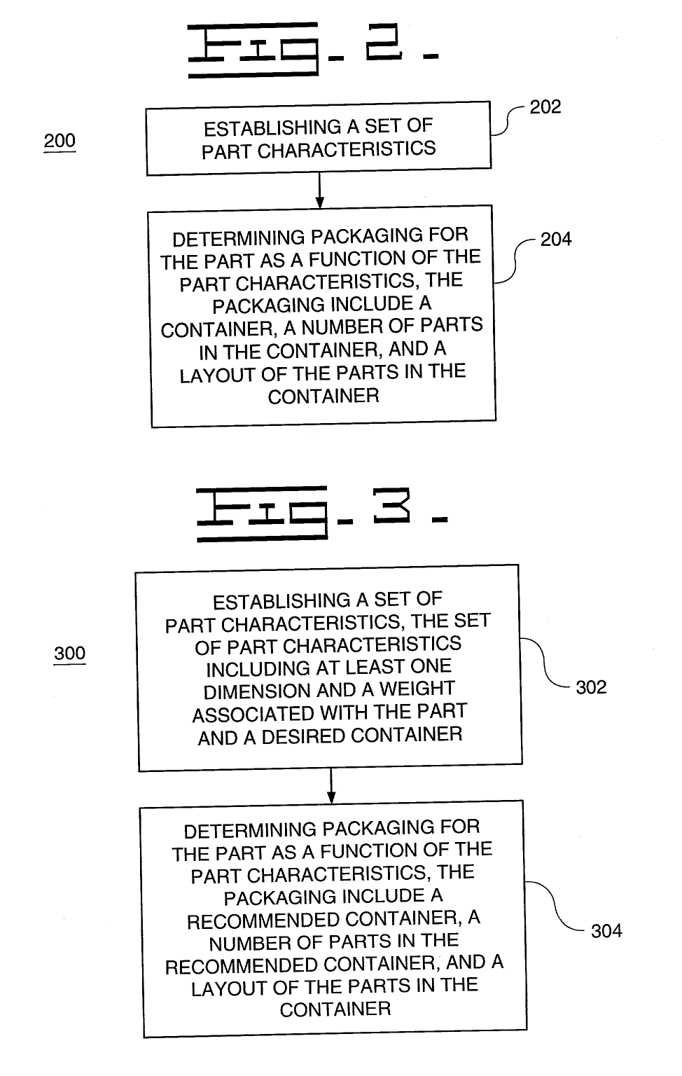

With reference to FIG. 2, a method 200 for determining a shipping configuration for a part, according to one embodiment of the present invention will now be described. In a first control block 202, a set of part characteristics is established. In a second control block 204 a shipping configuration for the part as a function of the part characteristics is determined. In one embodiment, the shipping configuration includes at least one of a container, a number of parts in the container, and/or a layout of the parts in the container.

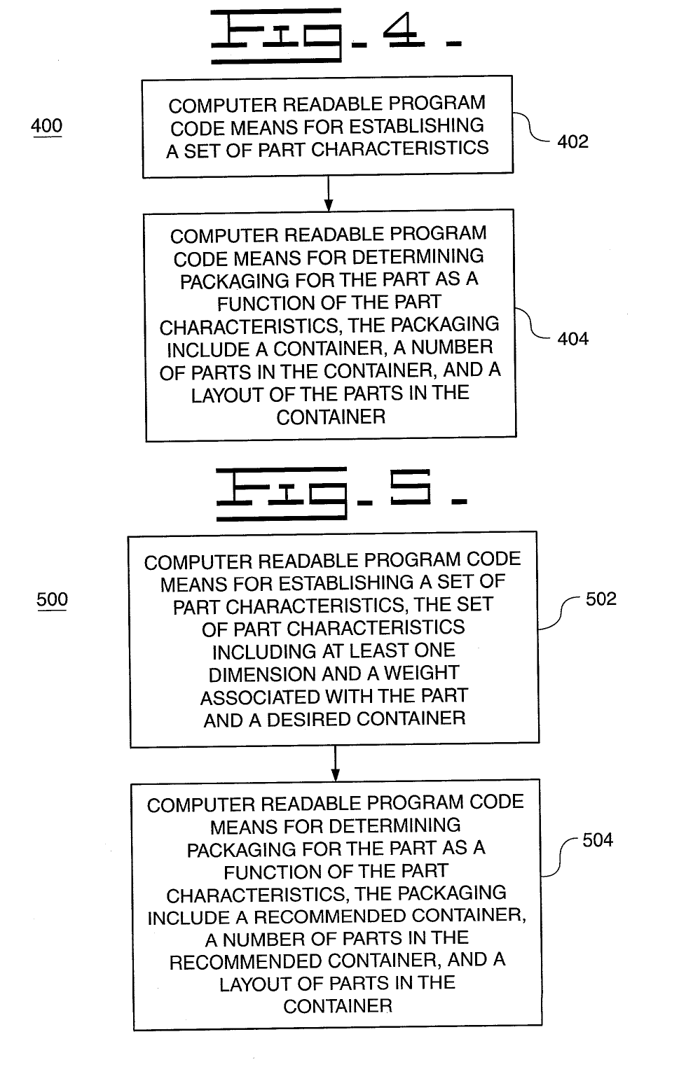

With reference to FIG. 3, a method 300 for determining a shipping configuration for a part, according to another embodiment of the present invention will now be described. In a third control block 302, a set of part characteristics is established. The set of part characteristics includes at least one dimension and a weight associated with the part and a desired container. In a fourth control block 304, the shipping configuration for the part is determined as a function of the part characteristics. In one embodiment, the shipping configuration includes at least one of a recommended container, a number of parts in the recommended container, and a layout of the parts in the recommended container.

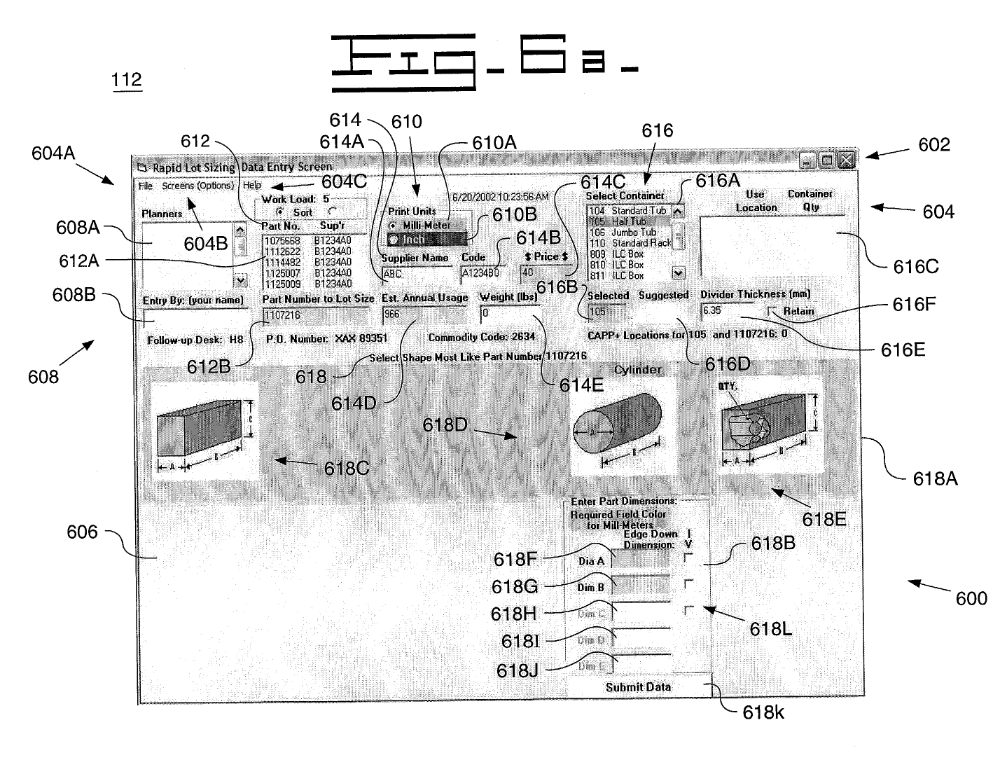

With reference to FIG. 4, a computer program product 400 determines a shipping configuration for a part, according to one embodiment of the present invention. A computer readable program code means 402 establishes a set of part characteristics. A computer readable program code means 404 determines the for the part as a function of the part characteristics. In one embodiment the shipping configuration includes at least one of a container, a number of parts in the container, and a layout of the parts in the container.

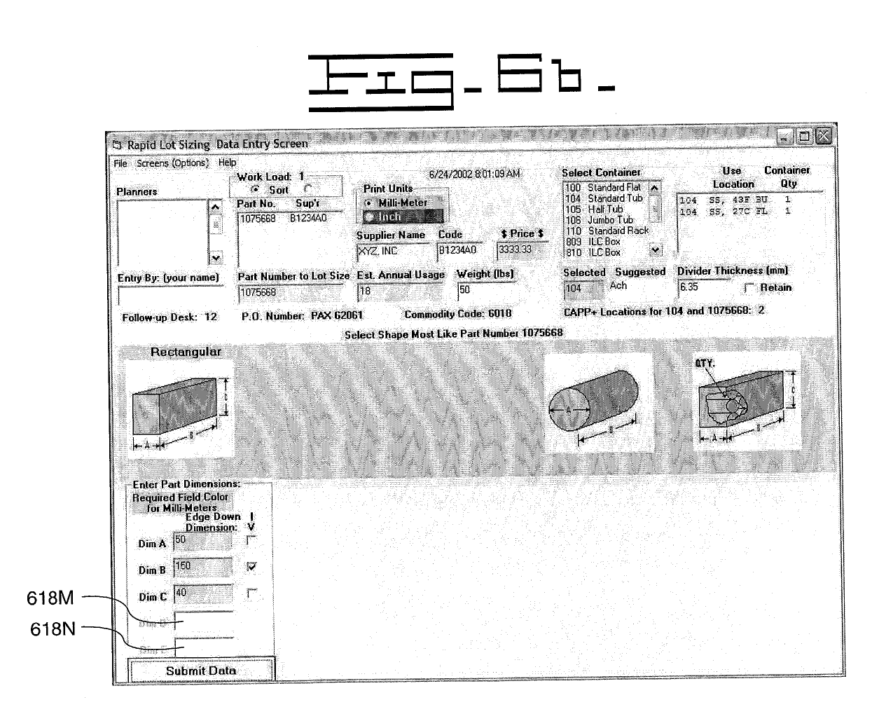

With reference to FIG. 5, a computer program product 500 determines a shipping configuration for a part, according to another embodiment of the present invention. A computer readable program code means 502 establishes a set of part characteristics. The set of part characteristics includes at least one dimension and a weight associated with the part and a desired container. A computer readable program code means 504 determines the shipping configuration for the part as a function of the part characteristics. In one embodiment, the shipping configuration includes at least one of AA recommended container, a number of parts in the recommended container, and a layout of the parts in the recommended container.

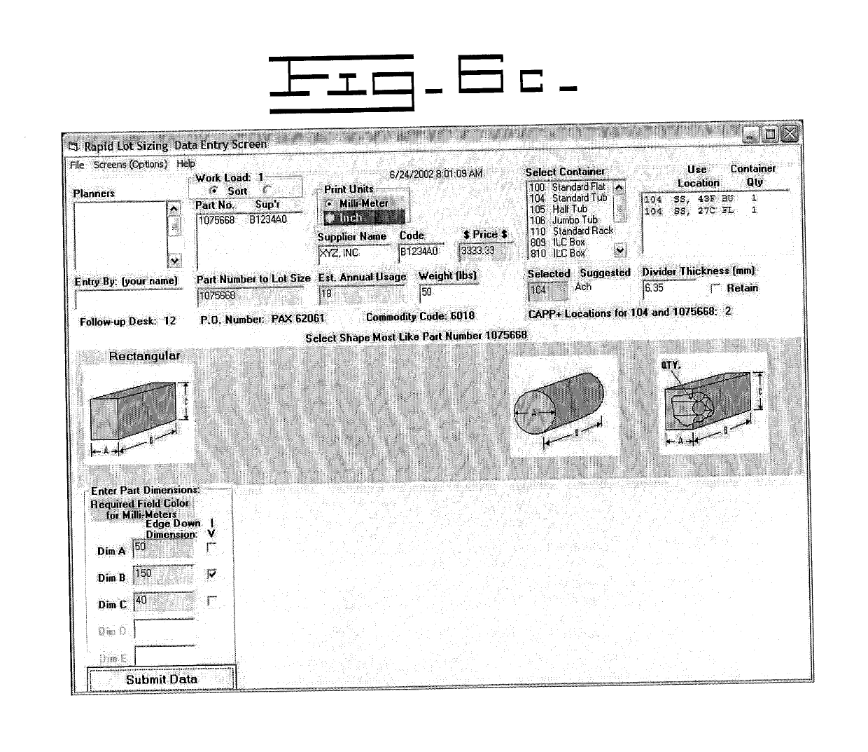

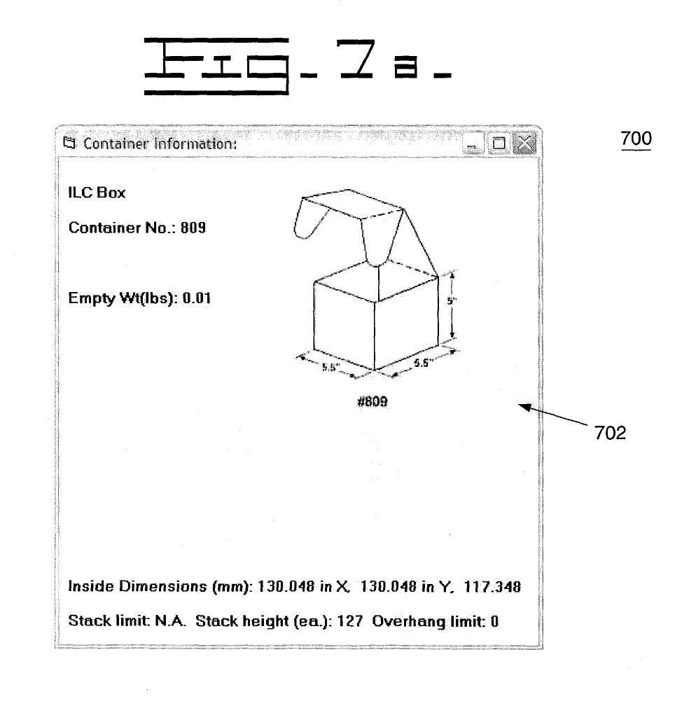

With reference to FIGS. 6A-9B, a graphic user interface (GUI) 112 according to an embodiment of the present invention will now be discussed.

With specific reference to FIGS. 6A, 6B, and 6C, the (GUI) 112 includes a data entry window 600. The data entry window 600 includes a title bar 602, a menu bar 604 and a data entry screen 606. The menu bar 604 includes three menus: a file menu 604A, a Screens menu 604B, and a Help menu 604C.

In one embodiment, the file menu 604A includes two menu items: “Print Screen” and “Exit”. Selection of Print Screen will print the screen to a default printer. Selection of Exit will exit all screens and exit the system 100. The Screens menu 604B includes four menu items: “Data Entry”, “History”, “Reporting”, and “Update Resource Files”. Selection of Data Entry displays the data entry screen 606. Selection of History displays a History screen (see below) from which the user 110 can access stored information. Selection of Reporting displays a Reporting screen (see below) from which the user 110 can generate various reports. Selection of the Update Resource Files provides a method in which the information stored in the database 102 can be updated from external sources. The Help menu 604C contains several items which provide access to general and specific help files.

The data entry screen 606 includes planner or user information section 608, a unit selector 610, a part information section 612, a procurement information section 614, a container information section 616, and a part shape information section 618.

The planner information section 608 is optional and may be used to identify the current user 110 of the system 100. In the illustrated embodiment, there are three ways for the current user 110 to enter their name. First, the current user 110 may select their name in a planner scroll down list 608A. Second, the current user's name may be typed into a planner entry box 608B. Third, the current user 110 may begin to type their name in the planner entry box 608B, a history list (not shown) will appear which contains a list of users who match the previously entered keystrokes. The current user 110 may then pick their name from the history list. The system 100 tracks changes by the user.

In the illustrated embodiment, the Unit Selection 610 includes a millimeter selector 610A and an inch selector 610B for selecting the units for part and container measurements.

The user 110 identifies the part for which they will be defining the shipping configuration using the part information section 612. The part information section 612 includes a part list 612A and a part number text entry box 612B. The part list 612A includes a list of available part numbers for the current user 110. In the illustrated embodiment, the part list 612A also includes a code identifying a supplier for the part. There are two ways in which the user 110 may enter the part number: (1) by selecting from the part list 612A or entering the part number into the part number text entry box 612B. To enter a new part number, the user 110 enters the part number in the part number text entry box 612B.

The procurement information section 614 contains information relating to the supplier for the selected part and additional information related to the part, e.g., a price related to the part, an estimated annual usage of the part, and a weight associated with the part. Some of the information may be automatically filled in the procurement information section 614 if the part was selected from the part list 612A or copied from history data (see below). If the current part is a new part or if the information had not been previously entered, the user 110 may enter the information directly into the procurement information section 614. In the illustrated embodiment, the procurement information section 614 includes a supplier name text entry box 614A, a supplier code text entry box 614B, a price entry box 614C, an estimated annual usage entry box 614D, and a weight entry box 614E.

The container information section 616 allows the user 110 to select a desired container for the part. The container information section 616 includes a container list 616A and a container entry box 616B. There are two methods in which a desired container may be selected: (1) the user 110 may select the desired container from the container list 616A or enter the desired container in the container entry box 616B.

The system 100 may also display information related to the quantity of containers at one or more facilities in a container location information box 616C. As described below, the system 100 may also suggest or determine a recommended container. The recommended container (if any) may be listed in a suggested container box 616D.

Furthermore, the system 100 may allow the user 110 to define a thickness of a divider in the container information section 616. In the illustrated embodiment, the container information section 616 includes a divider thickness entry box 616E and a retain divider thickness check box 616F.

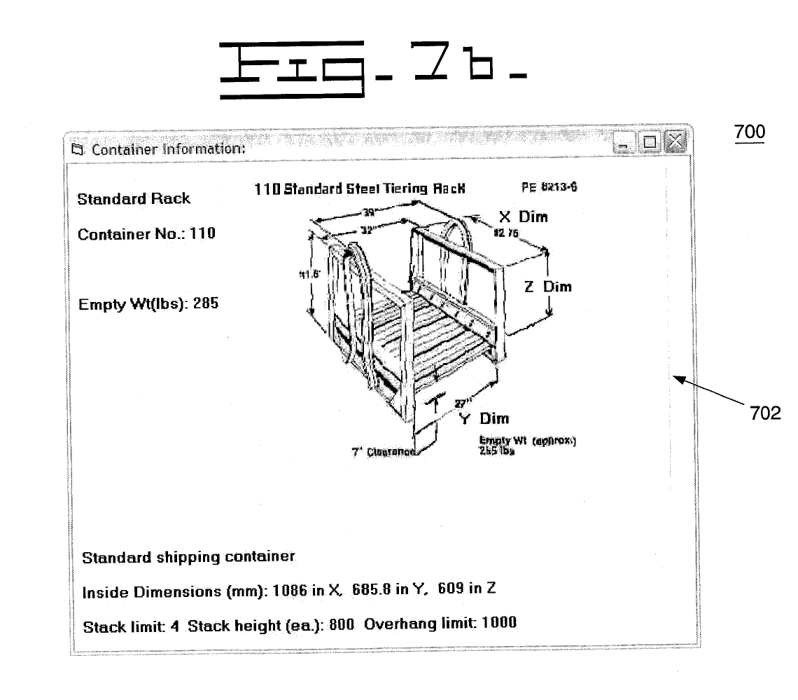

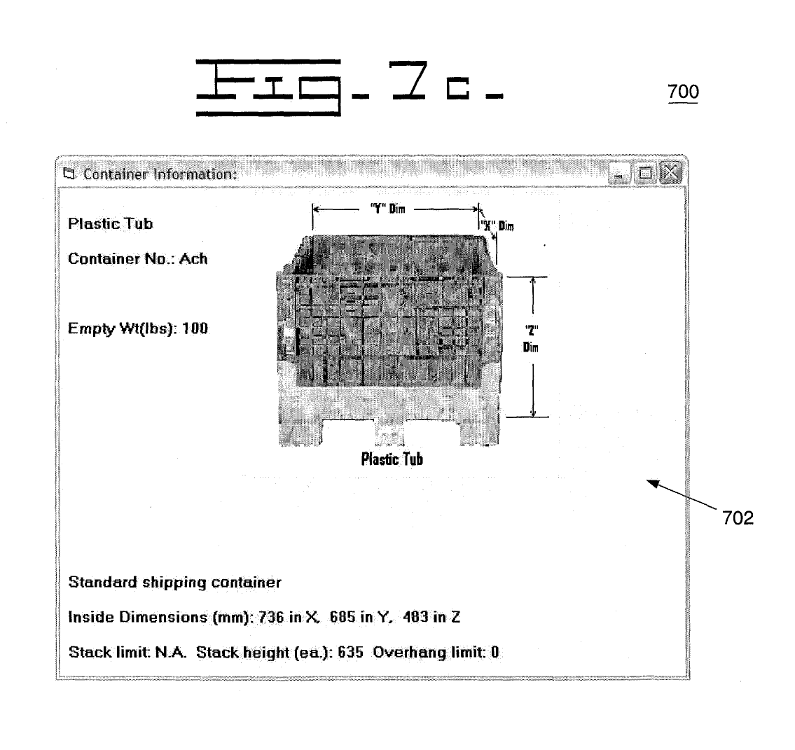

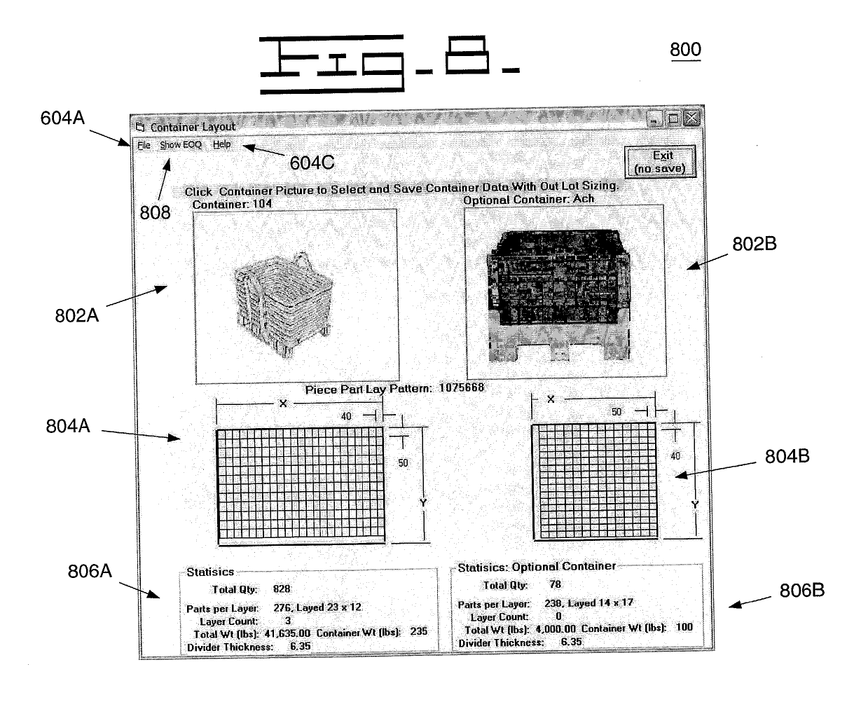

With reference to FIGS. 7A-7B, in one embodiment of the present invention, after the user 110 selects a desired container in the container information section 616, the system 100 displays a container information window 700. The container information window 700 contains information related to the desired container. In the illustrated embodiment, the container information window 700 includes a graphic 702 illustrating the desired container and additional information which may include container identifying information, an empty weight of the container, dimensional data, a stack limit, a stack height, and an overhang limit. The graphic may be either a drawing or a picture of the container. FIGS. 7A, 7B, and 7C contain sample information for three standard containers: an ILC box #809, a 110 standard steel tiering rack, and a plastic tub, respectively.

Returning to FIG. 6A, the system 100 further allows the user 110 to define the shape and size of the current part in the shape information section 618. In the illustrated embodiment, the shape information section 618 includes a predefined shape section 618A and a part dimension entry section 618B. The shape information section 618A includes a plurality of predefined shapes. The user 110 may select the shape which most closely resembles the actual shape of the current part. In the illustrated embodiment, the shape information section 618A includes three predefined shapes: a box 618C, a cylinder 618D, and a package of parts 618E. However, it should be noted that additional predefined shapes may be included.

Each shape has a plurality of dimensions which should be defined. For example, the box predefined shape 618C has dimensions a, b, and c which should be defined. The cylinder predefined shape has dimensions a and b which must be defined. The part dimension entry section 618B includes a plurality of dimension entry boxes 618F, 618G, 618H, 6181, 618J. When a predefined shape 618C, 618D, 618E is selected the corresponding number of dimension entry boxes 618F, 618G, 618H, 6181, 618J become active. As shown in FIG. 6A, when the cylinder predefined shape 618D is selected, the first two dimension entry boxes 618F, 618G become active.

The part dimension entry section 618B also includes a submit data button 618K and a plurality of edge down check boxes 618L (corresponding to each active dimension entry box 618F, 618G, 618H, 618I, 618J). Once all the required information is entered, the submit data button 618K becomes active. Additionally, the plurality of edge down check boxes 618L allows the user to select which edge should be orientated downwards in the container. Only one of the edge down check boxes 618L may be selected.

With particular reference to FIG. 6B, the package of parts predefined shape 618E allows the user to define either a package containing a plurality of parts (as shown) or to define a group of the current parts which when placed together have the illustrated shape. For example, the current part may be prepackaged in a box containing a plurality of parts.

Alternatively, the part may be irregularly shaped or have a shape different than one of the predefined shapes. This option allows the user 110 to group two or more parts together in a manner which resembles the selected shape. For example, if a part has a triangle shaped cross section, two parts may be placed together such that they form a box shape.

When one package of parts predefined shape 618E is selected, three dimensions should be defined (a, b, and c). Furthermore, the quantity of parts contained within the package of parts should be entered into a quantity entry box 618M. Additionally, a weight of the total package may be entered into a weight entry box 618N.

In one aspect of the present invention, the following information is used: part number, print units, price, estimated annual usage, desired or selected container, and the dimensions of the selected predefined part shape.

The contents of the part dimension entry section 618B when the box predefined shape 618C is selected is shown in FIG. 6C. Additionally, for discussion purposes only, the following information has been entered on the data entry screen 606:

| | | |
|---|---|---|
| part: | 1075668 | |
| weight: | 50 | lbs, |
| estimated annual usage: | 18 | |
| desired container: | 104 | |
| divider thickness: | 6.35 | mm |

rectangular shaped part with a, b, c dimensions of 50 mm, 150 mm, and 40 mm, respectively.

After all of the information is entered into the data entry screen 606, the submit data button 618K becomes active. Selection of the submit data button 618K activates the system 100 to determine a recommended container, a part layout for the desired and recommended container and economic order quantity estimate information (see below).

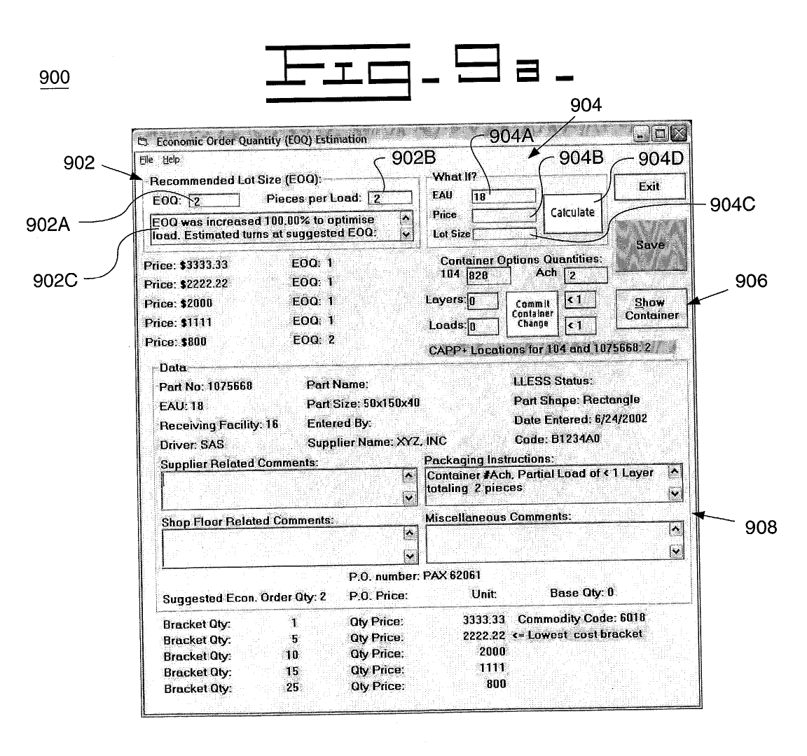

With reference to FIG. 8, after the submit data button 618K has been actuated a container layout window 800 is displayed by the system 100. The container layout screen 800 illustrated in FIG. 8 is based on the information shown on the data entry screen 606 shown in FIG. 6C.

The container layout screen 800 includes a first graphic 802A and a second graphic 802B. The first graphic 802A displays the desired container and the second graphic 802B displays the recommended container (if any). It should be noted that if there is no recommended container or if the desired container will not work because of the dimension or weight requirements of the part and/or container, then no graphic is shown.

In one embodiment of the present invention, the container layout screen 800 includes a first layout pattern 804A and a second layout pattern 804B. The container layout screen 800 also includes a first statistics section 806A and a second statistics section 806B. The first layout pattern 804A and the first statistics section 806A are related to the recommended container and the second layout pattern 804B and the second statistics section 806B are related to the recommended container.

The recommended container is based (in part) on the part, i.e., dimensions and weight and on a recommended lot size, i.e., number of parts ordered at any one time. The recommended lot size is based on an economic analysis based on part price and annual estimated usage, as well as internal costs involved with ordering, storing, handling, etc . . . . the received parts (see below).

The first layout pattern 804A displays how the parts should be placed in the desired container based on the size (dimensions), shape, and weight of the container and the part, as well as any weight limit of the container and the designated edge orientation (see above). The number of parts may be modified by the desired economical lot size (see below). Alternatively, the number of parts may be the number of parts which will fit in the container given all the limitations, such as weight limit.

The second layout pattern 804A displays how the parts should be placed in the recommended container based on the size (dimensions), shape, and weight of the container and the part, as well as any weight limit of the container and the designated edge orientation (see above). The number of parts may be limited by the recommended lot size (see below). Alternatively, the number of parts may be the number of parts which will fit in the container given all the limitations, such as weight limit.

The recommended container may then be determined based on how many parts will fit into a given container. In one embodiment, the system 100 determines how many parts will fit into each available container using an iterative loop. For example, for each container the system 100 determines the number of parts that will fit into a container for each possible orientation of the part. In one embodiment, the container which will hold or fit the largest number of parts without exceeding a most economical lot size is chosen as the recommended container. Alternatively, the container which cost effectively holds the parts may be selected. For example, the user 110 selects a type of container. Based on the estimated annual usage, the parts would fit into 1½ of these containers, whereas two smaller containers or a single larger container may be more cost effective (based on other factors, see below).

For example, in FIG. 8, the desired container is the 104 standard steel tote box #104. The first layout pattern 804A illustrates the recommended layout of parts in each layer of parts for the desired container, 50 rows of 40 parts. The first statistics section 806C contains additional information, i.e., the total quantity of parts in the container, the number pf parts per layer, the number of layers, the total weight, and the divider thickness.

In the given example, the recommended container is a plastic tub (“Ach”). In a similar manner, the second layout pattern 804B and the second statistics section 806B illustrate the recommended layout of parts in the recommended container and additional information.

The system 100 may determine a most economic lot size as a function of the part price and the estimated annual usage. In one aspect of the present invention, the most economic lot size is also determined as a function of external factors such as supply chain costs, for example, inventory costs and holding, distribution, receiving costs, current part prices, past part prices, and/or a forecast of future part prices. In one embodiment of the present invention, the external factors are estimated using a predetermined factor. The predetermined factor, however, may be modified or updated to reflect changes in the external factors.

In one embodiment of the present invention, the most economical lot size is determined using an experimentally derived formula. In another embodiment of the present invention, the most economic lot size is determined using a plurality of experimentally derived formula, where each formula is used over a predetermined range of part quantities.

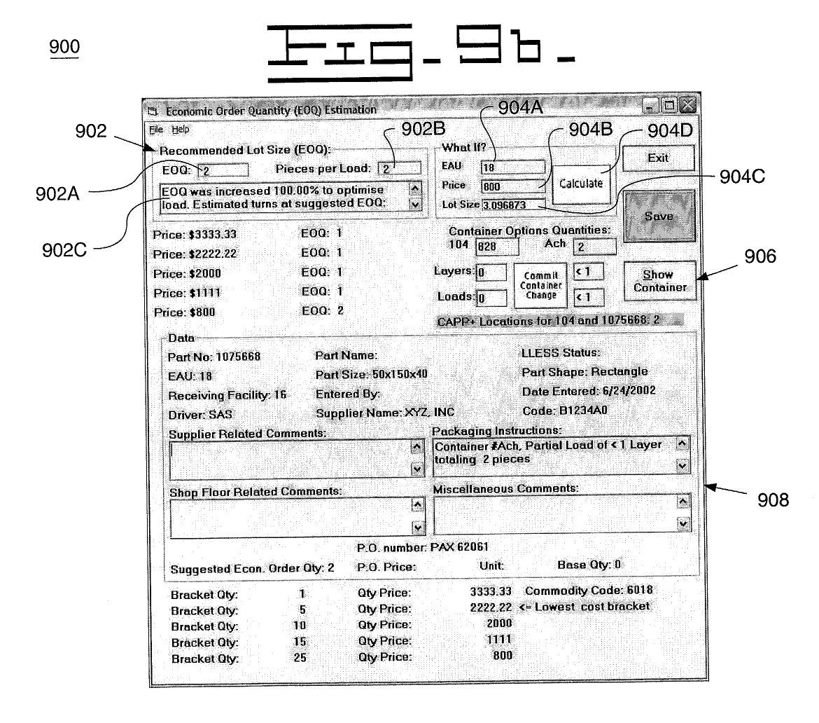

Referring again to FIG. 8, the container layout window 800 includes a Show EOQ menu item 808. With reference to FIGS. 9A and 9B, selection of the Show EOQ menu item 808 displays an economic order quantity (EOQ) estimation window 900. The EOQ estimation screen 900 includes a recommended lot size section 902, a what if section 904, a container summary section 906, and a data section 908.

The recommended lot size section 902 includes a EOQ text box 902A, a pieces per load text box 902B, and a EOQ note box 902C. The EOQ text box 902A displays the determined most economic lot size and the pieces per load text box 902B displays the number of parts per load (container).

The container summary section 902C contains summary information related to the recommended and desired containers. Additional information regarding the supplier of the part is located in the data section 908.

The what if section 904 allows the user 110 to enter certain information to see how this would affect the most economic lot size. In the illustrated embodiment, the what if section 904 includes a EQU entry box 904A and a price entry box 904B. The user 110 may enter different values to determine how it impacts the recommended lot size. Once this information is entered, a calculate button 904C becomes active.

With reference to FIG. 9B, when the calculate button 904C is actuated, the system 100 calculates a new lot size and displays it in a lot size box 904D.

Industrial Applicability

With reference to the drawings and in operation, the present invention provides a system 100 and method 200, 300 for determining a shipping configuration for parts. The system 100 and method 200, 300 are utilized by a user 110 or planner to designate the shipping configuration for a particular part. The user 110 defines the part, i.e., its shape, size and weight and other attributes of the part, includes price and estimate annual usage.

The shipping configuration may include a container, a number of parts in the container, and a layout of the parts in the container.

The user 110 may also designate a desired container in which the part is to be shipped.

The system 100 and method 200, 300, using the input data, may also determine the most economic lot size for the part to be shipped. Based on the most economic lot size, the system 100 and method 200, 300 may also determine a recommended container. The system 100 and method 200, 300 may also generate an image of the container and a layout illustrating the best layout of parts within either the desired or recommended container or both.

Other aspect and features of the present invention can be obtained from a study of the drawings, the disclosure, and the appended claims.

What is claimed is:

1. A method of determining a shipping configuration for a part, comprising the steps of:
establishing a set of part characteristics; and,
determining the shipping configuration for the part as a function of the part characteristics, the shipping configuration including a container and a number of parts relative to the container.

2. A method, as set forth in claim 1, wherein the shipping configuration, and a layout of the parts in the container.

3. A method, as set forth in claim 1, wherein the shipping configuration is determined as a function of a packaging database.

4. A method, as set forth in claim 1, wherein the step of establishing a set of part characteristics includes the step of establishing a part identification.

5. A method, as set forth in claim 1, wherein the step of establishing a set of part characteristics includes the step of establishing at least one dimension associated with the part.

6. A method, as set forth in claim 5, wherein the step of establishing a set of part characteristics includes the step of establishing a weight associated with the part.

7. A method, as set forth in claim 6, wherein the step of establishing a set of part characteristics includes the step of establishing a part identification and wherein the at least one dimension and the weight associated with the part are determined as a function of the part identification.

8. A method, as set forth in claim 7, wherein the part identification is input by a user.

9. A method, as set forth in claim 6, wherein the at least one dimension associated with the part and the weight associated with the part are input by a user.

10. A method, as set forth in claim 9, wherein the step of establishing a set of part characteristics includes the step of establishing a desired container.

11. A method, as set forth in claim 10, wherein the container is the desired container.

12. A method, as set forth in claim 11, wherein the container is a recommended container.

13. A method, as set forth in claim 12, wherein the shipping configuration includes the desired container, a number of parts in the desired container, and a layout of the parts in the desired container.

14. A method, as set forth in claim 1, wherein the step of establishing a set of part characteristics includes the step of establishing a dimension for a plurality of edges of the part.

15. A method, as set forth in claim 14, wherein the step of establishing a set of part characteristics further includes the step of establishing one of the edges as having a specific orientation.

16. A method, as set forth in claim 1, including the step of providing a user interface for receiving input from a user.

17. A method, as set forth in claim 1, including the step of establishing a set of usage characteristics for the part, and wherein the shipping configuration is determining as a function of the part characteristics and the usage characteristics.

18. A method, as set forth in claim 17, wherein the usage characteristics includes at least one of a part price and a part usage number.

19. A method, as set forth in claim 18, wherein the part usage number is a number of parts used during a year's time period.

20. A method, as set forth in claim 17, wherein the usage characteristics includes a part price and a part usage number.

21. A method, as set forth in claim 20, wherein the part usage number is a number of parts used during a year's time period.

22. A method, as set forth in claim 17, wherein the container is a desired container and the method further includes the step of determining an economic lot size as a function of the usage characteristics.

23. A method, as set forth in claim 22, further including the step of determining a recommended container as a function of the economic lot size.

24. A computer based system for determining a shipping configuration for a part, comprising:
a database for storing packaging data; and,
a processing unit, coupled to the database, for establishing a set of part characteristics and determining the shipping configuration for the part as a function of the part characteristics, the shipping configuration including a container and a number of parts in the container.

25. A system as set forth in claim 24 wherein the shipping configuration includes a layout of the parts relative to the container.

26. A system, as set forth in claim 24, wherein the shipping configuration is determined as a function of a packaging database.

27. A system, as set forth in claim 24, wherein the processing unit establishes a part identification.

28. A system, as set forth in claim 24, wherein the processing unit establishes at least one dimension associated with the part.

29. A system, as set forth in claim 28, wherein the processing unit establishes a weight associated with the part.

30. A system, as set forth in claim 29, wherein the processing unit establishes a part identification and wherein the at least one dimension and the weight associated with the part are determined as a function of the part identification.

31. A system, as set forth in claim 30, wherein the part identification is input by a user.

32. A system, as set forth in claim 29, wherein the at least one dimension associated with the part and the weight associated with the part are input by a user.

33. A system, as set forth in claim 32, wherein the processing unit establishes a desired container.

34. A system, as set forth in claim 33, wherein the container is the desired container.

35. A system, as set forth in claim 32, wherein the container is a recommended container.

36. A system, as set forth in claim 34, wherein the shipping configuration includes the desired container, a number of parts in the desired container, and a layout of the parts in the desired container.

37. A system, as set forth in claim 24, wherein the processing unit establishes a dimension for a plurality of edges of the part.

38. A system, as set forth in claim 37, wherein the processing unit establishes one of the edges as having a specific orientation.

39. A system, as set forth in claim 25, further comprising a user interface for receiving input from a user.

40. A system, as set forth in claim 25, including the processing unit establishes a set of usage characteristics for the part, and wherein the shipping configuration is determining as a function of the part characteristics and the usage characteristics.

41. A system, as set forth in claim 40, wherein the usage characteristics includes at least one of a part price and a part usage number.

42. A system, as set forth in claim 31, wherein the part usage number is a number of parts used during a year's time period.

43. A system, as set forth in claim 40, wherein the usage characteristics includes a part price and a part usage value.

44. A system, as set forth in claim 43, wherein the part usage value is a number of parts used during a year's time period.

45. A system, as set forth in claim 40, wherein the container is a desired container and the processing unit determines a most economic lot size as a function of the usage characteristics.

46. A system, as set forth in claim 45, wherein the processing unit determines a recommended container as a function of the most economic lot size.

47. A method of determining a shipping configuration for a part, comprising the steps of:
establishing a set of part characteristics, the set of part characteristics including at least one dimension and a weight associated with the part; and,
determining the shipping configuration for the part as a function of the part characteristics, the shipping configuration including a recommended container and a number of parts in the recommended container.

48. A method, as set forth in claim 47, wherein the set of part characteristics includes a desired container.

49. A method, as set forth in claim 47, wherein the shipping configuration includes a layout of the parts in the recommended container.

50. A method, as set forth in claim 47, wherein the recommended container is the desired container.

51. A method, as set forth in claim 47, wherein the recommended container is not the desired container.

52. A method, as set forth in claim 47, including the step of providing a user interface for receiving input from a user.

53. A method, as set forth in claim 47, including the step of establishing a set of usage characteristics for the part, and wherein the shipping configuration is determining as a function of the part characteristics and the usage characteristics.

54. A method, as set forth in claim 53, wherein the container is a desired container and the method further includes the step of determining a most economic lot size as a function of the usage characteristics.

55. A computer based system for determining a shipping configuration for a part, comprising:
a database for storing packaging data; and,
a processing unit, coupled to the database, for establishing a set of part characteristics, the set of part characteristics including at least one dimension and a weight associated with the part and a desired container, and for determining the shipping configuration for the part as a function of the part characteristics, the shipping configuration including a recommended container, a number of parts in the recommended container, and a layout of the parts in the recommended container.

56. A system, as set forth in claim 51, wherein the recommended container is the desired container.

57. A system, as set forth in claim 51, wherein the recommended container is not the desired container.

58. A system, as set forth in claim 51, including the step of providing a user interface for receiving input from a user.

59. A system, as set forth in claim 51, including the step of establishing a set of usage characteristics for the part, and wherein the shipping configuration is determining as a function of the part characteristics and the usage characteristics.

60. A system, as set forth in claim 55, wherein the container is a desired container and the method further includes the step of determining a most economic lot size as a function of the usage characteristics.

61. A computer program product for determining a shipping configuration for a part, comprising:
computer readable program code means for establishing a set of part characteristics; and,
computer readable program code means for determining the shipping configuration for the part as a function of the part characteristics, the shipping configuration including a container, a number of parts in the container, and a layout of the parts in the container.

62. A computer program product for determining a shipping configuration for a part, comprising the steps of:
computer readable program code means for establishing a set of part characteristics, the set of part characteristics including at least one dimension and a weight associated with the part and a desired container; and,
computer readable program code means for determining a shipping configuration for the part as a function of the part characteristics, the shipping configuration including a recommended container, a number of parts in the recommended container, and a layout of the parts in the recommended container.

63. A method of selecting a shipping configuration for packing a designated part, comprising the steps of:
establishing a plurality of characteristics of the designated part, the plurality of characteristics including a number of parts to be shipped;
establishing a container to ship the number of parts; and,
establishing the shipping configuration in response to the plurality of part characteristics and the container.

64. A method, as set forth in claim 63, wherein the shipping configuration includes at least one of a layout of the parts relative to the container, a number of parts that will fit in the container, and a weight of the parts that will fit into the container.

65. A method of identifying a shipping configuration associated with a designated part, comprising the steps of:
establishing a number of parts to be shipped;
establishing a cost characteristic associated with the part; and
identifying the shipping configuration associated with the designated part.

66. A method, as set forth in claim 65, further including the step of establishing a set of part characteristics, wherein the shipping configuration is determined as a function of the part characteristics.

67. A method, as set for in claim 66, wherein the part characteristics include at one of a recommended number of parts to be shipped and a recommended container.

68. A method, as set forth in claim 64, wherein the cost characteristics include a cost of the part.

69. A method, as set forth in claim 64, wherein the cost characteristics include a storage cost associated with the part.
